(19) United States
(12) Patent Application Publication
(10) Pub. No.: US 2007/0236119 A1
(43) Pub. Date: Oct. 11, 2007

(54) METHODS AND APPARATUS FOR THERMAL MANAGEMENT AND LIGHT RECYCLING

(76) Inventor: Frederick M. Espiau, Topanga, CA (US)

Correspondence Address: SCHWEGMAN, LUNDBERG & WOESSNER, P.A., P.O. BOX 2938, MINNEAPOLIS, MN, 55402, US

(21) Appl. No.: 11/733,580

(22) Filed: Apr. 10, 2007

Related U.S. Application Data
(60) Provisional application No. 60/791,307, filed on Apr. 11, 2006.

(51) Int. Cl. H01K 1/30

(52) U.S. Cl. 313/110

(57) ABSTRACT

Physical configurations of a bulb (gas fill) for the purpose of thermal management and light recycling in order to increase lamp lifetime and efficiency are described. Example embodiments are applied to an electrode-less radio frequency (RF)/microwave discharge lamp comprising a bulb, electrical resonant or matching circuit, and electrical energy source. The example embodiments described herein are extendable to inductively, capacitively, and cavity coupled lamps.

### CROSS REFERENCE RELATED APPLICATION

This application claims the benefit of priority of U.S. Provisional Application Ser. No. 60/791,307 filed Apr. 11, 2006, entitled “ELECTRODE-LESS PLASMA LAMP: METHODS FOR THERMAL MANAGEMENT AND LIGHT RECYCLING” which application is incorporated herein by reference.

### FIELD

This application relates to a method and apparatus for thermal management and light recycling.

### BACKGROUND

Plasma discharges provide extremely bright, broadband light useful in a myriad of applications including, but not limited to projection systems, industrial lighting and processing, sports lighting, and other general lighting applications. Typical plasma lamps manufactured today contain a mixture of gases and light emitting substances that are excited to form a plasma. Gas ionization resulting in plasma formation can be accomplished in several ways, including, but not limited to: electrical conduction of a high current (charge mediated energy transfer) through closely spaced electrodes contained within the bulb or through coupling approaches that transfer RF energy to the gas mixture within the bulb (electrode-less approaches). Inductive coupling permeates the bulb with a strong magnetic field that mediates the energy transfer to the plasma, capacitively coupling permeates the bulb with an electric field that transfers RF energy to the plasma, while in microwave coupling both electric and magnetic fields mediate the energy transfer.

Plasma discharges of the type described above are capable of producing light with free space wavelengths ranging from 300 to 1000 nm and can yield luminance levels of 1G candle/m². Given the fundamental relation between a body's luminance and Planck's radiation law necessitates that a plasma yielding 1 G candle/m² have a temperature in the 6000 to 8000 K range. Plasma spatial confinement and thermal management become a bulb reliability issue given typical bulb material melting temperatures of ˜1500 K. For typical 7500 K discharges, temperature within the bulb drops below 2000 K at ˜2 mm from the plasma, thereby constraining bulb wall to plasma separation.

In etendue limited applications plasma discharge geometry is a critical design consideration. Lamps incorporating electrodes internal to the bulb, control plasma discharge shape and position within the bulb through electrode geometry. Consequently, bulb walls can be removed from the plasma vicinity lessening concerns regarding bulb material integrity. In electrode-less lamps (such as capacitively coupled for example); however, plasma discharge shape is significantly controlled by bulb geometry, constraining the position of the plasma discharge relative to the bulb walls. In electrode-less approaches thermal management and bulb wall temperature regulation become enablers of bulb lifetime extensions critical to practical applications.

Furthermore, in etendue limited applications only a fraction of the overall plasma discharge geometry is used by the collection optics. Light generated by the plasma outside this useful zone is wasted by the collection optics. Reflection of this unused light back into the plasma enhances electrical to optical conversion and minimizes wasted energy.

### BRIEF DESCRIPTION OF THE DRAWINGS

In the figures and description, numerals indicate various features of the example embodiments, and like numerals refer to like features throughout both the drawings and the description.

FIG. 1a depicts a generalized schematic of a capacitively coupled lamp, an RF energy source feeds energy to the bulb that creates and sustains the plasma discharge contained within the bulb, also shown in the figure is the dominant polarization direction of the RF field.

FIG. 1b depicts a generalized schematic of the bulb under operation, the schematic emphasizes both optical and thermal radiation from the bulb while the plasma is sustained.

FIG. 1c depicts a generalized, prior art schematic of a microwave coupled bulb, the RF energy source is not shown, and a dielectric waveguide acts to couple RF energy to the plasma (no electrodes are attached to the bulb).

FIG. 2 depicts a generalized schematic of the capacitively coupled lamp, the RF energy source having been replaced by an RF source, amplifier, and impedance matching circuit, and thermal management being an important design consideration.

FIG. 3 depicts an example capacitively coupled bulb, the bulb wall temperature is regulated via thermal radiation through the electrodes, in particular the electrodes are wrapped over the bulb wall edges to increase radiator surface area. The metallization on the side walls also reflects unused light back into the plasma in a light recycling scheme. The drawing on the left shows the generalized bulb schematic, while the one on the right is a cross section of the bulb through the dashed line.

FIG. 4 depicts an example capacitively coupled bulb, the electrodes mediate thermal management, electrode surface area may be increased through the use of radiating fins, fins may be formed from a high thermal conductivity material of low dielectric constant, a high thermal conductivity and dielectric constant material has been added between the vessel and the electrodes. This layer of material at each end of the bulb may act as an end cap enhancing bulb wall integrity.

FIG. 5 depicts an example capacitively coupled bulb, primary electrodes (which deliver RF energy to the bulb) mediate thermal management, thick layers of high thermal conductivity and low dielectric constant material separate the primary and secondary electrodes, the secondary electrodes act solely as thermal radiators, RF energy is delivered to the bulb through the thick dielectric layers.

FIG. 6 depicts a bulb design in accordance with an example embodiment, thermal management being mediated through electrodes, and light recycling being enabled through reflective layers deposited on the bulb side walls.

FIG. 7a depicts a capacitively coupled bulb, in accordance with an example embodiment, incorporated into a reflector for etendue limited applications, thermal management being mediated through radiation fins on one side of the bulb and through thermal contact to the reflector on the other side, and a reflective coating recycling unused light enhancing lamp efficiency.

FIG. 7b depicts an microwave coupled lamp, in accordance with an example embodiment, employing both thermal management and light recycling.

### DETAILED DESCRIPTION

Example embodiment relate to physical and geometrical configurations and methods for the removal of thermal energy (heat) and the recycling of optical energy (e.g., electromagnetic radiation with free space wavelengths ranging between 300 nm and 1 μm, light), particularly as it applies to the field of plasma lamps, and still more particularly to plasma lamps incorporating a radio frequency (RF) source whereby the electrical energy is coupled to the bulb through inductive or capacitive or microwave (the bulb resides within a waveguide/cavity that mediates the RF energy coupling to the bulb) coupling.

### Overview

Example embodiments of this invention may provide distinct advantages over electrode-less plasma lamps in the background art. Firstly, using especially designed thermal radiating structures may ensure bulb wall reliability. These can be formed from dielectric materials or metal stacks designed to operate at the elevated temperatures of the bulb. Moreover, in addition to enabling thermal management these structures can be used to recycle unused light back into the plasma.

In one example embodiment, a lamp includes an amplified RF source operating in the frequency range between 10 MHz and 10 GHz and emitting between 50 and 200 W. The lamp further includes an external resonator in the embodiment of a lumped circuit or dielectric cavity or can resonator, which follows the RF source and is intended to provide the necessary potential drop to sustain the plasma. In its simplest implementation the resonant circuit comprises a parallel matching network, but is not limited to this configuration, and all other configurations are meant for inclusion by extension. RF energy sustains the plasma through capacitively coupling, electrodes incorporated onto the bulb, but not in bulb. A diffusive, etch resistant dielectric layer separates the electrodes from the bulb walls. Radiating fins are part of the bulb and aid in bulb wall temperature management. Optically reflective layers deposited on the bulb sidewalls reflect unused light back into the plasma.

In another example embodiment, a method for producing light includes: a) directing RF/microwave energy at a bulb, b) coupling RF energy to the gas fill within the bulb via electrode-less coupler, mediating bulb wall temperature management through thermal radiation geometries, and d) reflecting of unused light back into the plasma.

A more complete understanding of the present invention and its advantages will be gained from a consideration of the following description of example embodiments, read in conjunction with the accompanying drawings provided herein.

### EXAMPLE EMBODIMENTS

While the present invention is open to various modifications and alternative constructions, the example embodiments shown in the drawings will be described here in detail. It is to be understood, however, that there is no intention to limit the invention to the particular forms disclosed. In fact, it is intended that the present invention cover all modifications, equivalences, and alternative constructions falling within the scope and the spirit of the invention as expressed in the claims herein. Further, the term “electrodes-less” is intended to include any lamp where electrodes for coupling power do not extend into the bulb.

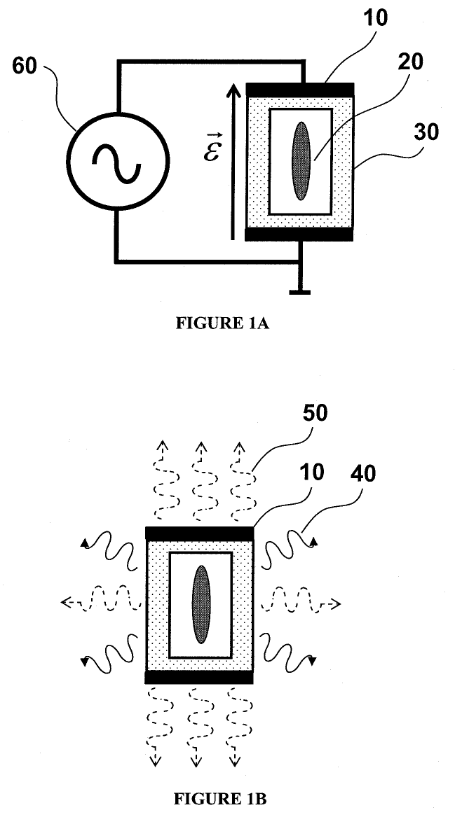

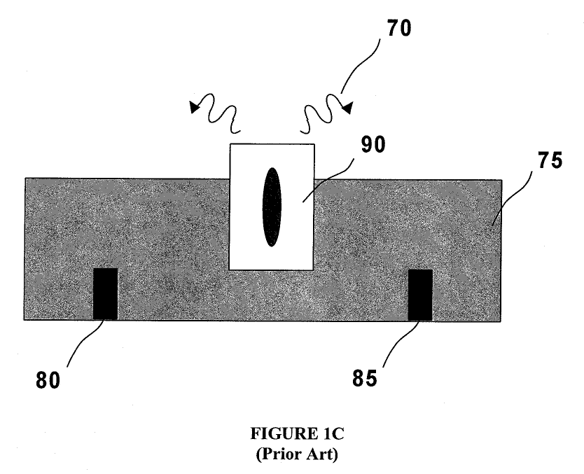

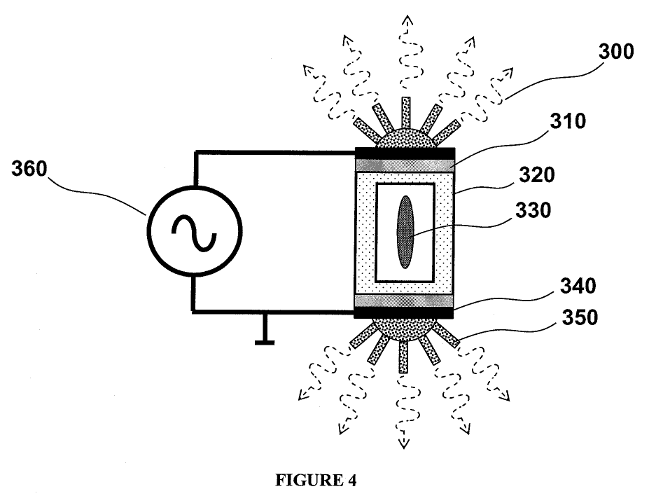

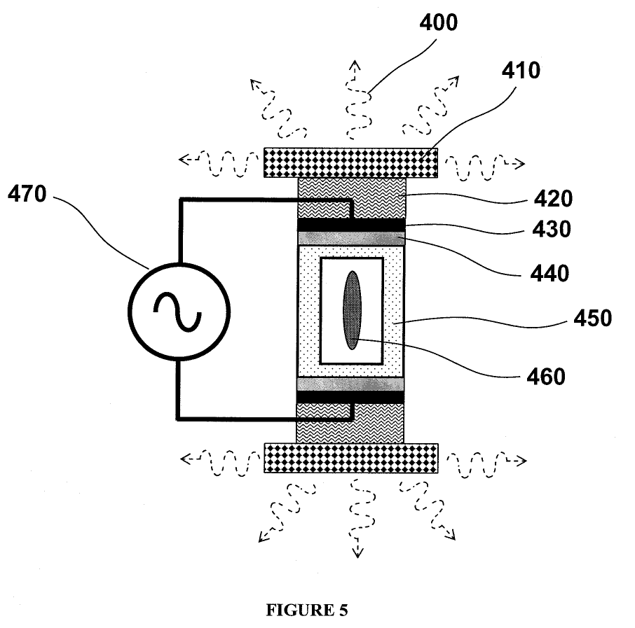

FIG. 1a illustrates a general/generic example embodiment of the electrode-less lamp. An electrical source 60 delivers energy to the plasma 20 contained in the bulb 30. Electrodes 10 deposited at the bulb ends capacitively couple the RF energy to the plasma, electrodes and plasma are physically separated by the bulb walls. The bulb (gas fill) contains gasses that transition into a plasma state under the presence of RF energy. Subsequently energy transfer between the plasma and the light emitters, also included in the bulb, gives rise to an intense light source. Typical spectrums range between 300 and 1000 nm. As described below with reference to FIGS. 4-7a, a dielectric layer (not shown in FIG. 1a) may be provided between bulb 30 and the electrodes 10.

FIG. 1b illustrates a bulb 30 with the plasma 20 formed within it. The plasma gives rise to optical radiation (light) 40 and thermal radiation (heat) 50. As described below with reference to FIGS. 4-7a, a dielectric layer (not shown in FIG. 1b) may be provided between bulb 30 and the electrodes 10. Light escapes the bulb through sidewalls composed of an optically transparent material, such as Quartz. The entirety of the bulb (Quartz vessel and metallic electrodes) radiates heat into the bulb environment. Through the use of high thermal conductivity metals, heat is pulled from the Quartz walls and into the bulb environment.

In an example embodiment, the electrodes may comprise metal stacks designed specifically for thermal radiation and enhancement of bulb wall integrity. Metals such as Alumina with melting temperatures exceeding 3500 K may be used as buffer materials between bulb walls and electrodes to inhibit the diffusion of other metals into the bulb wall. Subsequent stacks of Cu and Au may be used given their much higher thermal conductivity and Au's inert chemical nature. Both Cu and Au melt at ˜1300 K necessitating the use of a buffer material.

FIG. 1c is a schematic of a prior art of a microwave discharge electrode-less lamp wherein the thermal management and light recycling approaches described herein may also be deployed. A bulb 90, made from quartz, is filled with an inert gas and salt material, and placed inside an opaque dielectric waveguide (resonator/cavity) 75. Only the tip of the bulb is shown to protrude from the resonator. The dielectric waveguide is made from a higher dielectric constant material as compared to that of the bulb. RF energy is coupled to the plasma through probe 80, and RF probe 85 provides feedback from the plasma to sustain RF oscillation. The dielectric waveguide couples the RF energy into the bulb to ionize the gas and melt/vaporize the salt. The interaction between the ionized gas and salt vapor causes light emission 70. The light is emitted from the top of the lamp only since it is surrounded with opaque dielectric.

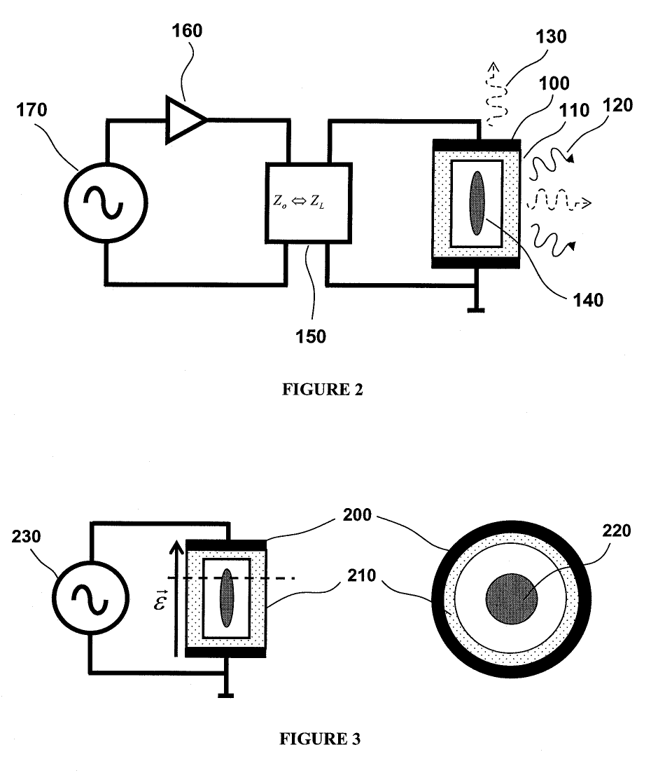

FIG. 2 illustrates an example capacitively coupled bulb 110 driven by the output of an impedance matching network 150, implemented either by a lumped or distributed circuit, for example in the form of an electrical resonator. The matching circuit is, in turn, driven by the output of a solid state amplifier 160, which amplifies the RF energy from the source 170. Light 120 emitted by the plasma 140 passes through the bulb sidewalls while thermal radiation 130 is radiated by the entirety of the bulb. Bulb electrodes 100 are designed to mediate the thermal radiation process and to regulate bulb wall temperature. As described below with reference to FIGS. 4-7a, a dielectric layer (not shown in FIG. 2) may be provided between bulb 110 and the electrodes 100.

FIG. 3 illustrates an example capacitively coupled bulb 210, with bulb electrodes 200 wrapped over the edges of the bulb 210 and partially covering the side walls. Light generated by the plasma 220 escapes from the bulb 210 through the fraction of the bulb walls not covered by electrodes 200. In many etendue sensitive applications only a small fraction of the light emitter may effectively contribute light to the collection optics, in any case. Extension of the electrode surface area may increase thermal radiation enabling more efficient bulb wall temperature regulation. Additionally, the wrapped electrodes act as reflectors delivering unused light back to the plasma 220. In an example embodiment, the recycled light may thus act as a pump to further enhance light output. Increasing electrode area also increases the lamp capacitance enhancing RF coupling to the plasma.

FIG. 4 illustrates a capacitively coupled bulb 320 in accordance with an example embodiment. An RF energy source 360 sustains a plasma 330 within the bulb 320 that gives off intense optical illumination. RF energy is capacitively coupled to the plasma through the bulb walls. High electrical and thermal conduction electrodes 340 are contacted to the bulb through a buffer layer 310, in the form of a high melting point material, intended to inhibit the diffusion of the electrodes into the bulb 320. A buffer layer 310 is provided at each end of the bulb 320. The buffer layer 310 may be alumina, or any material dielectric material capable of withstanding a high temperature). Radiating fins 350 are incorporated into the bulb electrodes, and may be composed of a high thermal conductivity material and are proportioned (shaped and dimensioned) to mitigate RF radiation thus ensuring that most of the RF energy is transferred to the bulb 320.

FIG. 5 illustrates a capacitively coupled bulb, in accordance with an example embodiment, similar to that described in FIG. 4. An RF source 470 is capacitively coupled to form a plasma 460 within a bulb 450. RF energy is delivered to the plasma 460 through electrodes 430 attached to the bulb 450. A diffusive barrier 440 of high dielectric material (e.g., alumina or any other suitable material) prevents electrode diffusion into the bulb wall and serves as an etch barrier. The diffusive barrier 440 also exhibits high thermal conductivity to aid bulb wall thermal management. A set of high thermal conductivity, low dielectric constant material stacks 420 provides thermal conduction between the bulb electrodes 430 and a set of thermal radiating plates 410. The radiating plates 410 and dielectric stacks 420 are chosen to conduct heat away from the bulb 450 thereby maintaining bulb wall integrity.

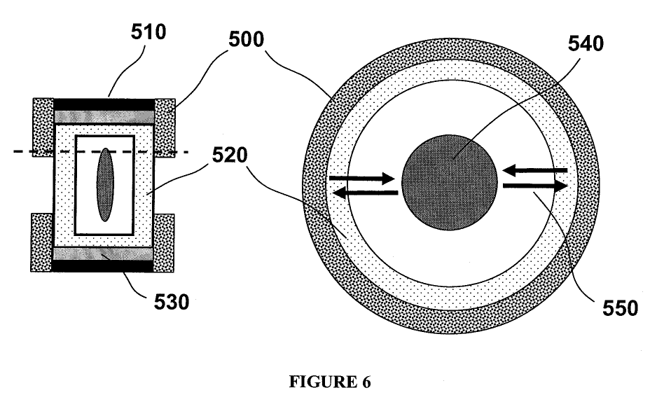

FIG. 6 illustrates a bulb, in accordance with an example embodiment, similar to that shown in FIG. 3. The bulb 520 may be made of Quartz and contain the plasma 540 sustained by an RF energy source, not shown. Electrodes 510 capacitively couple the RF energy to the plasma through a diffusive, etch barrier 530 of high dielectric constant material or high melting point metal. A fraction of the bulb sidewalls are covered by a reflective film 500, which may consist of metal or dielectric. Light reflected 550 from these films is reflected back into the plasma 540 enhancing electrical to light conversion efficiency.

This approach may be particularly useful in etendue limited applications. In such cases only a small fraction of the geometrical extent of the plasma discharge is effectively used by the collection optics. Reflecting light from portions of the unused plasma discharge enhances lamp efficiency by using light (energy) that would otherwise be wasted.

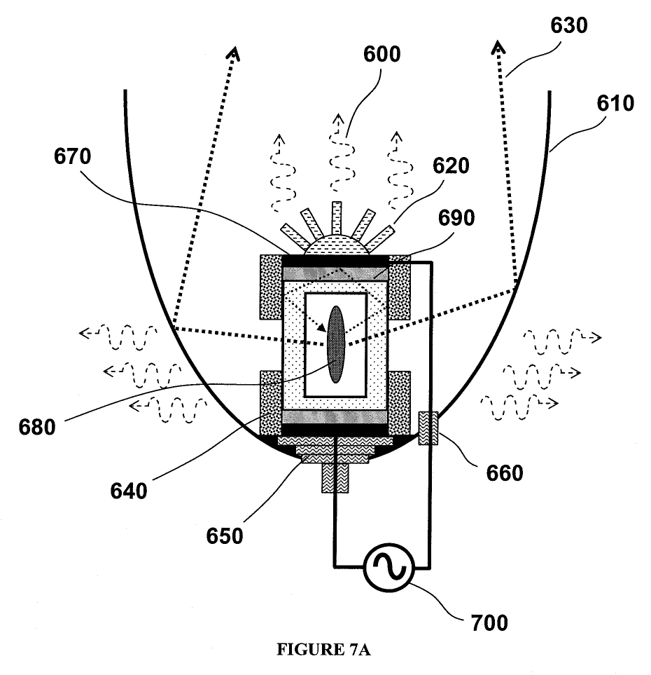

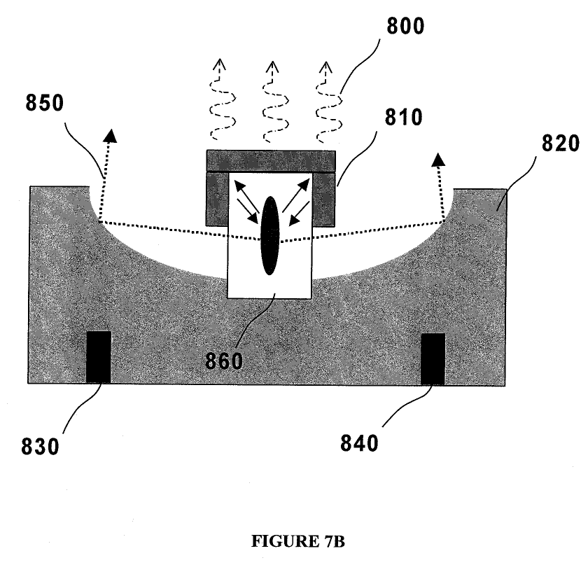

FIG. 7a illustrates a bulb, in accordance with an example embodiment, similar to that shown in FIG. 4 but which incorporates a reflector 610. An RF source 700 capacitively couples energy to the plasma 680 through electrodes 670 in contact with a diffusive, etch layer 690. Radiating fins 620 are incorporated into one side of the bulb to enhance thermal radiation 600 from the bulb into the environment thereby managing bulb wall temperature. Unused light from the plasma is reflected from reflective layers 640 incorporated onto the bulb sidewalls. Light 630 is directed toward the collection optics by the reflector 610. The bulb is attached to the reflector 610 through a set of high thermal conductivity, dielectric layers 650, thereby enabling the reflector 610 as a thermal radiator.

FIG. 7b illustrates an example lamp similar to that shown in FIG. 1c, in this case the dielectric waveguide/resonator 820 has been shaped as a reflector to collect the light from the bulb 860. Unlike the geometry depicted in FIG. 1c, light 850 is collected from the sides of the bulb enabling collection from a fraction of the plasma discharge, critical to etendue limited applications. The bulb top is coated by a high thermal conductivity dielectric stack 810, which acts simultaneously as enhanced heat radiator 800 and optical mirror. RF energy is fed to the plasma through RF probe 830 and feedback to sustain oscillation is obtained through RF probe 840.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An electrode-less plasma lamp comprising:
a bulb including a fill;
first and second coupling components located at opposed ends of the bulb, the coupling components configured to capacitively couple RF energy to the fill; and
reflective material located proximate the opposed ends of the bulb to reflect light generated by a plasma when the bulb receives RF energy back towards the plasma.

2. The plasma lamp of claim 1, wherein the bulb comprises:
reflective zones defined by the reflective material where light from the plasma is reflected back towards the plasma; and
a transmissive zone between the reflective zones to allow light to exit the bulb.

3. The plasma lamp of claim 1, wherein the reflective material is a reflective coating.

4. The plasma lamp of claim 1, comprising a dielectric layer located between each of the first and second coupling elements and a corresponding opposed end of the bulb.

5. The plasma lamp of claim 4, wherein the dielectric layer is of a reflective dielectric material, the reflective dielectric layer and the reflective material being configured to reflect light back towards the plasma.

6. The plasma lamp of claim 4, wherein each dielectric layer defines an end cap in which the opposed ends of the bulb are received.

7. The plasma lamp of claim 4, wherein the dielectric layer has a high thermal conduction coefficient.

8. The plasma lamp of claim 7, wherein the dielectric layer is alumina.

9. The plasma lamp of claim 4, wherein the dielectric layer has a thickness of less than 2 mm.

10. The plasma lamp of claim 1, wherein the bulb is elongated in shape and rectangular in cross section.

11. The plasma lamp of claim 1, comprising at least one heat sink located in contact with an associated end of the bulb to dissipate heat from the associated end of the bulb.

12. The plasma lamp of claim 11, wherein the heat sink comprises radiating fins to enhance the radiation of heat from the heat sink.

13. The plasma lamp of claim 1, comprising:
a first heat sink located in contact with the first coupling component; and
a second heat sink located in contact with the second coupling component, the first and second heat sinks being configured to dissipate heat from corresponding ends of the bulb.

14. The plasma lamp of claim 13, wherein the first and second coupling components are configured to enhance dissipation of heat from the ends of the bulb and conduct heat towards the first and second heat sinks.

15. The plasma lamp of claim 13, wherein the heat sinks are configured to cool ends of the bulb to space ends of the plasma from the ends of the bulb.

16. The plasma lamp of claim 1, wherein the reflective material defines a reflective mirror at each end of the bulb.

17. A method of increasing lamp efficiency of an electrode-less plasma lamp, the method comprising:
providing a bulb including a fill;
providing first and second coupling components located at opposed ends of the bulb, the coupling components configured to capacitively couple RF energy to the fill; and
reflecting light generated by a plasma when the bulb receives RF energy back towards the plasma utilizing reflective material located proximate the opposed ends of the bulb.

18. The method of claim 17, comprising:
reflecting light back towards the plasma in reflective zones defined by the reflective material; and
transmitting light from the bulb in a transmissive zone located between the reflective zones.

19. The method of claim 17, comprising dissipating heat from an end of the bulb utilizing at least one heat sink located in contact with the end of the bulb.

20. The method of claim 17, comprising dissipating heat from first and second ends of the bulb using a first heat sink located in contact with the first coupling component, and a second heat sink located in contact with the second coupling component.

21. The method of claim 17, comprising cooling ends of the bulb using heat sinks to space ends of the plasma from the ends of the bulb.
